(19) United States
(12) Patent Application Publication
(10) Pub. No.: US 2026/0140019 A1
(43) Pub. Date: May 21, 2026

(54) SHOCK ABSORBER PERFORMANCE TESTING DEVICE AND METHOD FOR VEHICLE ENGINEERING

(71) Applicants: Shanghai Zhongqiao Vocational and Technical University, Shanghai (CN); Wenzhou University of Technology, Wenzhou (CN); Wenzhou Zecheng Mechanical & Electrical Equipment Co., Ltd., Wenzhou (CN)

(72) Inventors: Shuxin Wang, Shanghai (CN); Yunyang Ye, Wenzhou (CN); Haishao Chen, Wenzhou (CN); Xiaojun Shen, Shanghai (CN); Liang Huang, Shanghai (CN); Mengji Xiong, Shanghai (CN); Yaohui Pan, Wenzhou (CN); Jiandong Lin, Wenzhou (CN)

(21) Appl. No.: 19/247,582

(22) Filed: Jun. 24, 2025

(30) Foreign Application Priority Data
Nov. 20, 2024 (CN) 202411659778.3

(51) Int. Cl. G01M 17/04

(52) U.S. Cl. CPC G01M 17/04

(57) ABSTRACT

Disclosed are a shock absorber performance testing device and method for vehicle engineering. The device includes a box body and a box door, where a U-shaped frame is fixedly connected to a bottom of the box body, a motor is fixedly connected to a bottom of the U-shaped frame, a rotating disk is fixedly connected to an output end of the motor, a moving block is connected to the rotating disk by a guide mechanism, two first connecting blocks symmetrically arranged are fixedly connected to a bottom of the moving block, two second connecting blocks symmetrically arranged are fixedly connected to a top of the rotating disk, and insertion holes are formed on side walls of the first and second connecting block. The present invention facilitates continuous multiple impact tests and adjusts the frequency and amplitude of the impact, thereby making the test more convenient and achieving better test results.

### CROSS-REFERENCE TO RELATED APPLICATIONS

This application claims priority to Chinese Patent Application No. 202411659778.3, filed on Nov. 20, 2024, which is hereby incorporated by reference in its entirety.

### TECHNICAL FIELD

The present invention relates to the technical field of shock absorber performance testing devices, and specifically to a shock absorber performance testing device and method for vehicle engineering.

### BACKGROUND

Impact testing is a critical methodology in industrial production and scientific research, which is widely used to evaluate the durability and toughness of materials or components when subjected to external shocks or abnormal loading conditions. In the field of vehicle engineering, shock absorbers must undergo performance testing via a performance testing device after being manufactured. The impact testing may evaluate the performance and effect of shock absorbers during impact to determine whether the shock absorbers meet the use requirements.

However, the existing shock absorber performance testing device and method for vehicle engineering lack of a capability for performing multiple consecutive impacts on the shock absorber when in use, and fail to adjust the frequency and amplitude of the impacts, thereby affecting the efficiency and effect of the test.

### SUMMARY

An objective of the present invention is to provide a shock absorber performance testing device and method for vehicle engineering, so as to solve the problems in the background.

To achieve the foregoing objective, the present invention provides the following technical solutions. A shock absorber performance testing device for vehicle engineering includes a box body and a box door, where a U-shaped frame is fixedly connected to a bottom of the box body, a motor is fixedly connected to a bottom of the U-shaped frame, a rotating disk is fixedly connected to an output end of the motor, a moving block is connected to the rotating disk by a guide mechanism, two first connecting blocks symmetrically arranged are fixedly connected to a bottom of the moving block, two second connecting blocks symmetrically arranged are fixedly connected to a top of the rotating disk, insertion holes are formed on side walls of the first connecting block and the second connecting block, a plurality of groups of guide rods arranged in an array are fixedly connected to the bottom of the box body, two guide rods are arranged in each group of guide rods, retaining rings are fixedly sleeved on side walls of each group of guide rods, a first sliding block is slidably connected to the side walls of each group of guide rods, a counterweight block is fixedly connected to a top of the first sliding block, the counterweight block is pushed by a first pushing mechanism to move, a detection mechanism configured to detect movement of the moving block is arranged on the top of the rotating disk, and an oiling mechanism configured to automatically apply lubricating oil to the guide rod is arranged on the top of the first sliding block.

Preferably, the first pushing mechanism includes a pushing block, the pushing block includes a first inclined surface, the first sliding block may slide on the first inclined surface, the first sliding block is connected to the top of the rotating disk by a lifting mechanism, a pointer is arranged on a side wall of the moving block, and a scale mark is arranged on a side wall of the pushing block.

Preferably, the lifting mechanism includes a first sleeve tube fixedly connected to a bottom of the pushing block, a first sleeve rod is inserted into the first sleeve tube, a lower end of the first sleeve rod is fixed to the top of the rotating disk, a threaded tube is fixedly connected to the bottom of the pushing block, a threaded rod is threadedly connected in the threaded tube, a lower end of the threaded rod is rotatably connected to the top of the rotating disk, and an adjusting nut is fixedly sleeved on a side wall of the threaded rod.

Preferably, the detection mechanism includes two symmetrically arranged second sleeve rods fixedly connected to the bottom of the moving block, a second sleeve tube is sleeved on a side wall of the second sleeve rod, and a lower end of the second sleeve is fixed to the top of the rotating disk.

Preferably, the detection mechanism includes a detection block fixedly connected to the side wall of the moving block, an L-shaped frame is fixedly connected to the top of the rotating disk, and a distance sensor is fixedly inserted into a top of the L-shaped frame.

Preferably, the oiling mechanism includes a second sliding block sleeved on the side wall of the guide rod, a first spring is fixedly connected between the second sliding block and the first sliding block, two hollow annular covers are fixedly connected to a top of the second sliding block, the annular cover is provided with a plurality of oil outlets arranged in an array near the side wall of the guide rod, and an oil supply mechanism configured to drive the oil outlet to discharge oil is provided on a top of the box body.

Preferably, the oil supply mechanism includes a plurality of oil tanks arranged in an array and fixedly connected to the top of the box body, a hose is fixedly connected to a bottom of each oil tank, a U-shaped tube is fixedly connected between tops of the two annular covers, a fixed tube is fixedly connected to a top of the U-shaped tube, a fixed cover is fixedly connected to an upper end of the fixed tube, a lower end of the hose is fixed to a top of the fixed cover, and an on-off mechanism is arranged in the fixed cover.

Preferably, the on-off mechanism includes a sliding plate slidably connected in the fixed cover, a circular hole is formed in a top of the sliding plate, two first supporting blocks symmetrically arranged are fixedly connected to a side wall of the sliding plate, a T-shaped guide rod is fixedly connected to a side wall of each first supporting block, a second supporting block is sleeved on a side wall of each T-shaped guide rod, the second supporting block is fixed to a side wall of the fixed cover, a second spring is sleeved on the side wall of each T-shaped guide rod, and the sliding plate is moved by a second pushing mechanism.

Preferably, the second pushing mechanism includes an L-shaped plate fixedly connected to the top of the first sliding block, the L-shaped plate includes a second inclined surface, a push rod is arranged at the side wall of the sliding plate, and an end part of the push rod may slide on the second inclined surface.

A shock absorber performance testing method for vehicle engineering using the shock absorber performance testing device for vehicle engineering includes the following steps:
S1: When a shock absorber body is subjected to performance test, two ends of the shock absorber body are respectively placed between the two first connection blocks and the two second connection blocks, and bolts are inserted into the insertion holes and into connection holes at the two ends of the shock absorber body for connection.
S2: The motor is started, and the motor rotates to drive the rotating disk to rotate. When the first inclined surface abuts against the first sliding block, the first sliding block is pushed to move upward along the side wall of the guide rod, and the counterweight block is driven to move upward synchronously. When the pushing block passes over the first sliding block, the first sliding block and the counterweight block move downward under the action of gravity and impact on the moving block, so that the shock absorber body is subjected to impact test. A plurality of first sliding blocks and counterweight blocks are provided, so as to perform multiple continuous impact tests on the shock absorber body during the rotation of the rotating disk.
S3: The distance sensor detects a moving speed of the detection block and the moving block, and also test the performance of the shock absorber body. In addition, an impact frequency may be adjusted by adjusting a speed of the motor and the rotating disk, so that the test is more convenient and faster, and the test effect is better.
S4: During the test, the adjusting nut rotates to drive the threaded rod to rotate, thereby driving the threaded tube and the first sleeve tube to rise and fall, and then driving the pushing block to rise and fall. An impact height of the first sliding block and the counterweight block is adjusted by the scale mark indicated by the pointer, so that an impact amplitude is adjusted conveniently, the applicability is stronger, and the use is more convenient.
S5: When the first sliding block moves upward along the side wall of the guide rod, the second sliding block is driven by the first spring to synchronously move upward. In a case that a surface of the guide rod is not lubricated enough, the second sliding block gets stuck when the second sliding block and the first sliding block move upward; in this case, the first spring is compressed, and a distance between the first sliding block and the second sliding block is smaller, so that the end part of the push rod slides on the second inclined surface, then the sliding plate is pushed to slide toward the fixed cover, and the circular hole coincides with the hose. Meanwhile, the second spring is compressed; in this case, the lubricating oil in the oil tank enters the fixed tube after passing through the hose and the circular hole, enters the annular cover through the U-shaped tube, and is sprayed out via the oil outlet, so that the lubricating oil is automatically applied to the surface of the guide rod, making the movement of the second sliding block and the first sliding block smoother, thereby ensuring the effect of the subsequent impact test.

Compared with the prior art, the present invention has the following beneficial effects:
According to the shock absorber performance testing device and method for vehicle engineering, the first pushing mechanism is provided. When a shock absorber body is subjected to performance test, two ends of the shock absorber body are respectively placed between the two first connection blocks and the two second connection blocks, and bolts are inserted into the insertion holes and into connection holes at the two ends of the shock absorber body for connection. The motor is started, and the motor rotates to drive the rotating disk to rotate. When the first inclined surface abuts against the first sliding block, the first sliding block is pushed to move upward along the side wall of the guide rod, and the counterweight block is driven to move upward synchronously. When the pushing block passes over the first sliding block, the first sliding block and the counterweight block move downward under the action of gravity and impact on the moving block, so that the shock absorber body is subjected to impact test. A plurality of first sliding blocks and counterweight blocks are provided, so as to perform multiple continuous impact tests on the shock absorber body during the rotation of the rotating disk. Meanwhile, the distance sensor detects a moving speed of the detection block and the moving block, and also test the performance of the shock absorber body. In addition, an impact frequency may be adjusted by adjusting a speed of the motor and the rotating disk, so that the test is more convenient and faster, and the test effect is better.

According to the shock absorber performance testing device and method for vehicle engineering, the lifting mechanism is provided. During the test, the adjusting nut rotates to drive the threaded rod to rotate, thereby driving the threaded tube and the first sleeve tube to rise and fall, and then driving the pushing block to rise and fall. An impact height of the first sliding block and the counterweight block is adjusted by the scale mark indicated by the pointer, so that an impact amplitude is adjusted conveniently, the applicability is stronger, and the use is more convenient.

According to the shock absorber performance testing device and method for vehicle engineering, the oiling mechanism is provided. When the first sliding block moves upward along the side wall of the guide rod, the second sliding block is driven by the first spring to synchronously move upward. In a case that a surface of the guide rod is not lubricated enough, the second sliding block gets stuck when the second sliding block and the first sliding block move upward; in this case, the first spring is compressed, and a distance between the first sliding block and the second sliding block is smaller, so that the end part of the push rod slides on the second inclined surface, then the sliding plate is pushed to slide toward the fixed cover, and the circular hole coincides with the hose. Meanwhile, the second spring is compressed; in this case, the lubricating oil in the oil tank enters the fixed tube after passing through the hose and the circular hole, enters the annular cover through the U-shaped tube, and is sprayed out via the oil outlet, so that the lubricating oil is automatically applied to the surface of the guide rod, making the movement of the second sliding block and the first sliding block smoother, thereby ensuring the effect of the subsequent impact test.

### BRIEF DESCRIPTION OF DRAWINGS

FIG. 1 is a schematic diagram of an overall structure of the present invention;

FIG. 2 is a schematic diagram of an internal structure of a box body according to the present invention;

FIG. 3 is a schematic diagram of a position of a lifting mechanism according to the present invention;

FIG. 4 is a schematic diagram of a position of an oiling mechanism according to the present invention;

FIG. 5 is a schematic diagram of an enlarged structure of A in FIG. 3;

FIG. 6 is a schematic diagram of an enlarged structure of B in FIG. 4; and

FIG. 7 is a schematic diagram of an enlarged structure of C in FIG. 6.

Reference numerals: 1. box body; 2. first pushing mechanism; 201. pushing block; 202. first inclined surface; 203. pointer; 204. scale mark; 205. guide rod; 206. retaining ring; 207. first sliding block; 208. counterweight block; 301. second sleeve rod; 302. second sleeve tube; 401. first sleeve tube; 402. first sleeve rod; 403. threaded tube; 404. threaded rod; 405. adjusting nut; 5. oiling mechanism; 501. second sliding block; 502. first spring; 503. annular cover; 504. oil outlet; 6. oil supply mechanism; 601. oil tank; 602. hose; 603. U-shaped tube; 604. fixed tube; 7. on-off mechanism; 701. fixed cover; 702. sliding plate; 703. circular hole; 801. first supporting block; 802. T-shaped guide rod; 803. second supporting block; 804. second spring; 9. second pushing mechanism; 901. L-shaped plate; 902. second inclined surface; 903. push rod; 10. box door; 11. U-shaped frame; 12. motor; 13. rotating disk; 14. moving block; 15. first connection block; 16. second connecting block; 17. insertion hole; 18. shock absorber body; 19. detection mechanism; 1901. detection block; 1902. L-shaped frame; 1903. distance sensor; 20. guide mechanism; 21. bolt; and 22. connection hole.

### DETAILED DESCRIPTION OF EMBODIMENTS

The following clearly and completely describes the technical solutions in embodiments of the present invention with reference to the accompanying drawings in embodiments of the present invention. It is clear that the described embodiments are merely a part rather than all of embodiments of the present invention. Based on the embodiments of the present invention, all other embodiments obtained by those of ordinary skill in the art without creative effort fall within the protection scope of the present invention.

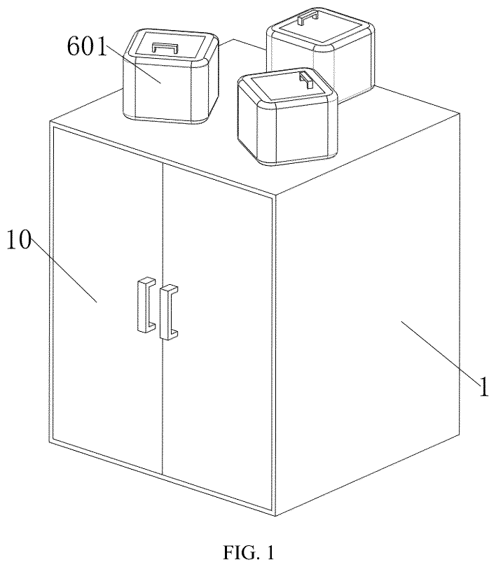

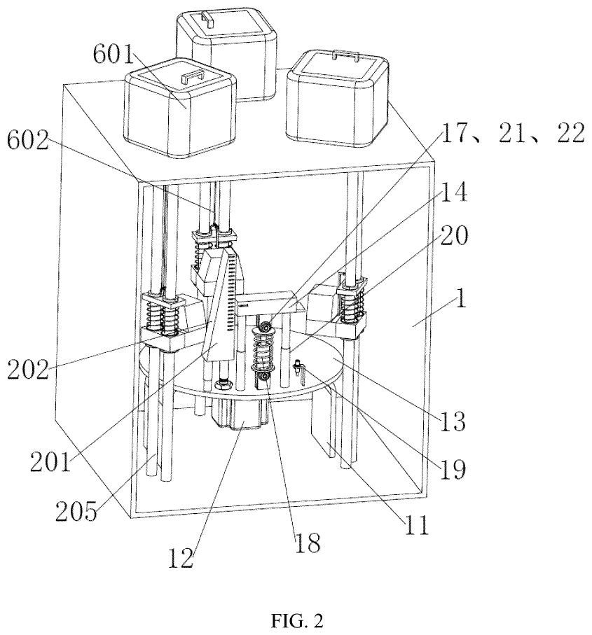

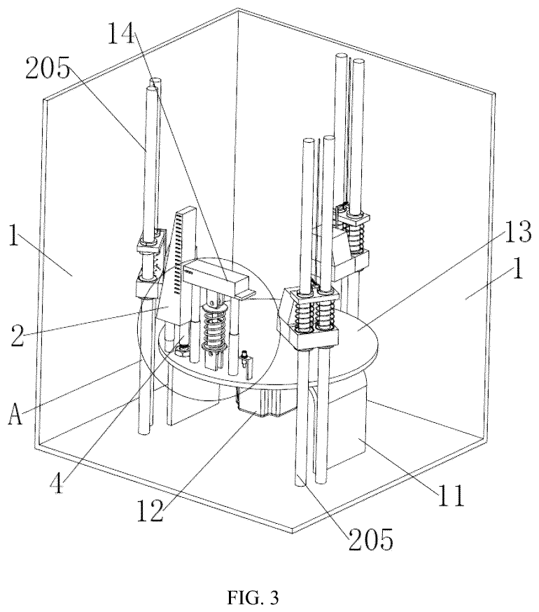

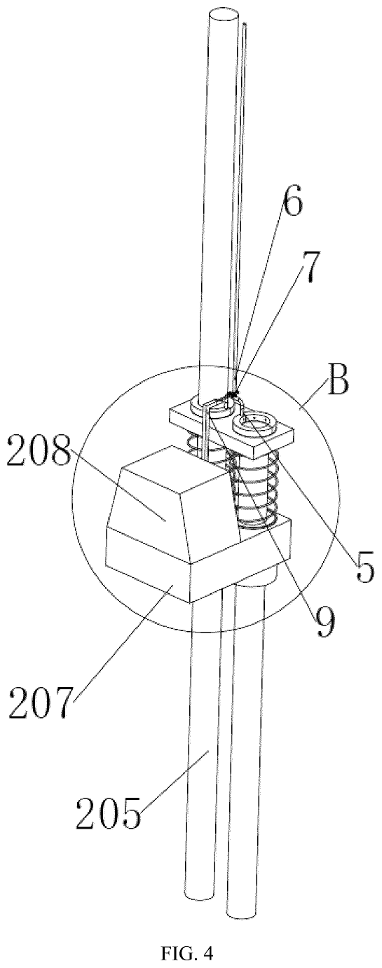

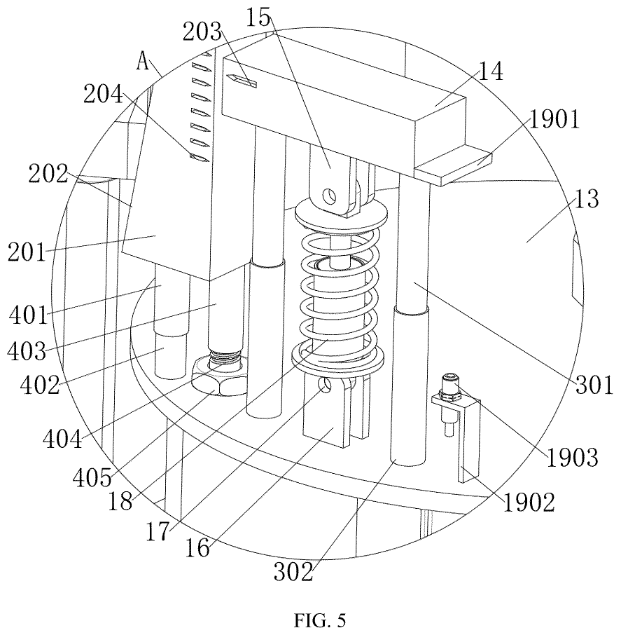

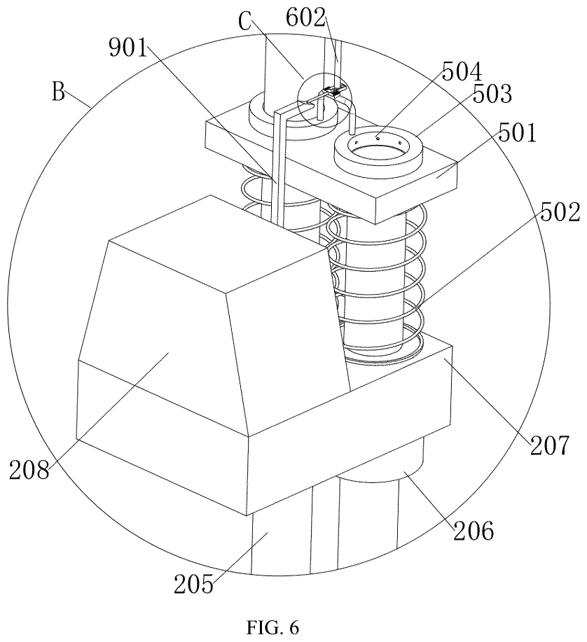

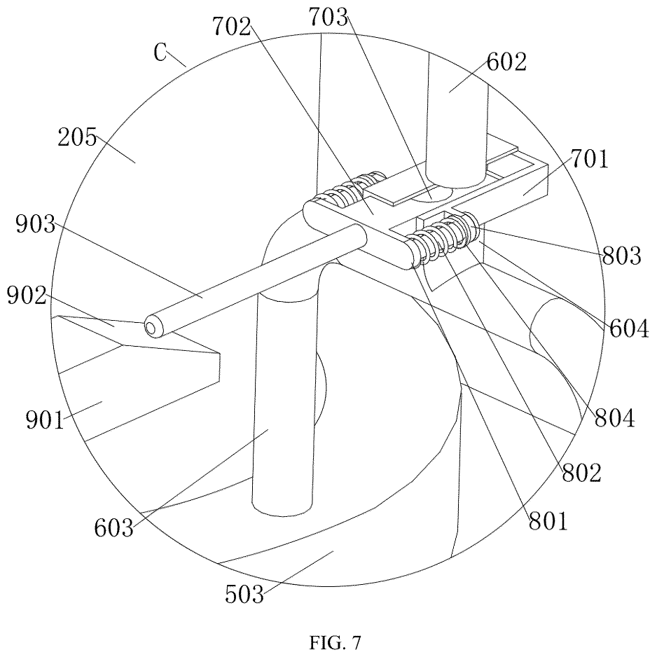

Referring to FIGS. 1 to 7, the present invention provides a technical solution of a shock absorber performance testing device for vehicle engineering, which includes a box body 1 and a box door 10, where a U-shaped frame 11 is fixedly connected to a bottom of the box body 1, a motor 12 is fixedly connected to a bottom of the U-shaped frame 11, a rotating disk 13 is fixedly connected to an output end of the motor 12, a moving block 14 is connected to the rotating disk 13 by a guide mechanism 20, two first connecting blocks 15 symmetrically arranged are fixedly connected to a bottom of the moving block 14, two second connecting blocks 16 symmetrically arranged are fixedly connected to a top of the rotating disk 13, insertion holes 17 are formed on side walls of the first connecting block 15 and the second connecting block 16, a plurality of groups of guide rods 205 arranged in an array are fixedly connected to the bottom of the box body 1, two guide rods 205 are arranged in each group of guide rods, retaining rings 206 are fixedly sleeved on side walls of each group of guide rods 205, a first sliding block 207 is slidably connected to the side walls of each group of guide rods 205, a counterweight block 208 is fixedly connected to a top of the first sliding block 207, the counterweight block 208 is pushed by a first pushing mechanism 2 to move, a detection mechanism 19 configured to detect movement of the moving block 14 is arranged on the top of the rotating disk 13, and an oiling mechanism 5 configured to automatically apply lubricating oil to the guide rod 205 is arranged on the top of the first sliding block 207, so as to facilitate continuous multiple impact tests on the shock absorber body 18 and adjust the frequency and amplitude of the impact, thereby making the test more convenient and quick and achieving better test results.

The first pushing mechanism 2 includes a pushing block 201, the pushing block 201 includes a first inclined surface 202, the first sliding block 207 may slide on the first inclined surface 202, the first sliding block 207 is connected to the top of the rotating disk 13 by a lifting mechanism 4, a pointer 203 is arranged on a side wall of the moving block 14, and a scale mark 204 is arranged on a side wall of the pushing block 201. The motor 12 is started, and the motor 12 rotates to drive the rotating disk 13 to rotate. When the first inclined surface 202 abuts against the first sliding block 207, the first sliding block 207 is pushed to move upward along the side wall of the guide rod 205, and the counterweight block 208 is driven to move upward synchronously. When the pushing block 201 passes over the first sliding block 207, the first sliding block 207 and the counterweight block 208 move downward under the action of gravity and impact on the moving block 14, so that the shock absorber body 18 is subjected to impact test.

The lifting mechanism 4 includes a first sleeve tube 401 fixedly connected to a bottom of the pushing block 201, a first sleeve rod 401 is inserted into the first sleeve tube 402, a lower end of the first sleeve rod 402 is fixed to the top of the rotating disk 13, a threaded tube 403 is fixedly connected to the bottom of the pushing block 201, a threaded rod 404 is threadedly connected in the threaded tube 403, a lower end of the threaded rod 404 is rotatably connected to the top of the rotating disk 13, and an adjusting nut 405 is fixedly sleeved on a side wall of the threaded rod 404. The adjusting nut 405 rotates, the rotation of the adjusting nut 405 drives the threaded rod 404 to rotate, thereby driving the threaded tube 403 and the first sleeve tube 401 to rise and fall, and then driving the pushing block 201 to rise and fall. An impact height of the first sliding block 207 and the counterweight block 208 is adjusted by the scale mark 204 indicated by the pointer 203, so that an impact amplitude is adjusted conveniently, the applicability is stronger, and the use is more convenient.

The detection mechanism 19 includes two symmetrically arranged second sleeve rods 301 fixedly connected to the bottom of the moving block 14, a second sleeve tube 302 is sleeved on a side wall of the second sleeve rod 301, and a lower end of the second sleeve 302 is fixed to the top of the rotating disk 13.

The detection mechanism 19 includes a detection block 1901 fixedly connected to the side wall of the moving block 14, an L-shaped frame 1902 is fixedly connected to the top of the rotating disk 13, and a distance sensor 1903 is fixedly inserted into a top of the L-shaped frame 1902. During the test, the distance sensor 1903 detects a moving speed of the detection block 1901 and the moving block 14, and also test the performance of the shock absorber body 18.

The oiling mechanism 5 includes a second sliding block 501 sleeved on the side wall of the guide rod 205, a first spring 502 is fixedly connected between the second sliding block 501 and the first sliding block 207, two hollow annular covers 503 are fixedly connected to a top of the second sliding block 501, the annular cover 503 is provided with a plurality of oil outlets 504 arranged in an array near the side wall of the guide rod 205, and an oil supply mechanism 6 configured to drive the oil outlet 504 to discharge oil is provided on a top of the box body 1. The oil supply mechanism 6 allows the lubricating oil to enter the annular cover 503 and then be sprayed out through the oil outlet 504, so that the surface of the guide rod 205 may be automatically coated with lubricating oil, making the movement of the second sliding block 501 and the first sliding block 207 smoother, thereby ensuring the effect of the subsequent impact test.

The oil supply mechanism 6 includes a plurality of oil tanks 601 arranged in an array and fixedly connected to the top of the box body 1, a hose 602 is fixedly connected to a bottom of each oil tank 601, a U-shaped tube 603 is fixedly connected between tops of the two annular covers 503, a fixed tube 604 is fixedly connected to a top of the U-shaped tube 603, a fixed cover 701 is fixedly connected to an upper end of the fixed tube 604, a lower end of the hose 602 is connected to a top of the fixed cover 701, and an on-off mechanism 7 is arranged in the fixed cover 701. When the first sliding block 207 moves upward along the side wall of the guide rod 205, the second sliding block 501 is driven by the first spring 502 to synchronously move upward. In a case that a surface of the guide rod 205 is not lubricated enough, the second sliding block 501 gets stuck when the second sliding block 501 and the first sliding block 207 move upward; in this case, the first spring 502 is compressed, and a distance between the first sliding block 207 and the second sliding block 501 is smaller, so that the on-off mechanism 7 is turned on. In this case, the lubricating oil in the oil tank 601 enters the fixed tube 604 after passing through the hose 602 and the circular hole 703, enters the annular cover 503 through the U-shaped tube 603, and is sprayed out via the oil outlet 504.

The on-off mechanism 7 includes a sliding plate 702 slidably connected in the fixed cover 701, a circular hole 703 is formed in a top of the sliding plate 702, two first supporting blocks 801 symmetrically arranged are fixedly connected to a side wall of the sliding plate 702, a T-shaped guide rod 802 is fixedly connected to a side wall of each first supporting block 801, a second supporting block 803 is sleeved on a side wall of each T-shaped guide rod 802, the second supporting block 803 is fixed to a side wall of the fixed cover 701, a second spring 804 is sleeved on the side wall of each T-shaped guide rod 802, and the sliding plate 702 is moved by a second pushing mechanism. In a case that a surface of the guide rod 205 is not lubricated enough, when the second sliding block 501 and the first sliding block 207 move upward, the second slider 501 may become stuck; in this case, the first spring 502 is compressed, and a distance between the first sliding block 207 and the second sliding block 501 is smaller, the second pushing mechanism 9 pushes the sliding plate 702 to slide into the fixed cover 701, so that the circular hole 703 coincides with the hose 602. In this case, the on-off mechanism 7 is turned on.

The second pushing mechanism 9 includes an L-shaped plate 901 fixedly connected to the top of the first sliding block 207, the L-shaped plate 901 includes a second inclined surface 902, a push rod 903 is arranged at the side wall of the sliding plate 702, and an end part of the push rod 903 may slide on the second inclined surface 902. When the distance between the first sliding block 207 and the second sliding block 501 becomes smaller, the end part of the push rod 903 slides on the second inclined surface 902, thereby pushing the sliding plate 702 to slide into the fixed cover 701.

A shock absorber performance testing method for vehicle engineering using the shock absorber performance testing device for vehicle engineering includes the following steps:
S1: When a shock absorber body 18 is subjected to performance test, two ends of the shock absorber body 18 are respectively placed between the two first connection blocks 15 and the two second connection blocks 16, and bolts 21 are inserted into the insertion holes 17 and into connection holes 22 at the two ends of the shock absorber body 18 for connection.
S2: The motor 12 is started, and the motor 12 rotates to drive the rotating disk 13 to rotate. When the first inclined surface 202 abuts against the first sliding block 207, the first sliding block 207 is pushed to move upward along the side wall of the guide rod 205, and the counterweight block 208 is driven to move upward synchronously. When the pushing block 201 passes over the first sliding block 207, the first sliding block 207 and the counterweight block 208 move downward under the action of gravity and impact on the moving block 14, so that the shock absorber body 18 is subjected to impact test. A plurality of first sliding blocks 207 and counterweight blocks 208 are provided, so as to perform multiple continuous impact tests on the shock absorber body 18 during the rotation of the rotating disk 13.
S3: The distance sensor 1903 detects a moving speed of the detection block 1901 and the moving block 14, and also test the performance of the shock absorber body 18. In addition, an impact frequency may be adjusted by adjusting a speed of the motor 12 and the rotating disk 13, so that the test is more convenient and faster, and the test effect is better.
S4: During the test, the adjusting nut 405 rotates, the rotation of the adjusting nut 405 drives the threaded rod 404 to rotate, thereby driving the threaded tube 403 and the first sleeve tube 401 to rise and fall, and then driving the pushing block 201 to rise and fall. An impact height of the first sliding block 207 and the counterweight block 208 is adjusted by the scale mark 204 indicated by the pointer 203, so that an impact amplitude is adjusted conveniently, the applicability is stronger, and the use is more convenient.
S5: When the first sliding block 207 moves upward along the side wall of the guide rod 205, the second sliding block 501 is driven by the first spring 502 to synchronously move upward. In a case that a surface of the guide rod 205 is not lubricated enough, the second sliding block 501 gets stuck when the second sliding block 501 and the first sliding block 207 move upward; in this case, the first spring 502 is compressed, and a distance between the first sliding block 207 and the second sliding block 501 is smaller, so that the end part of the push rod 903 slides on the second inclined surface 902, then the sliding plate 702 is pushed to slide toward the fixed cover 701, and the circular hole 703 coincides with the hose 602. Meanwhile, the second spring 804 is compressed; in this case, the lubricating oil in the oil tank 601 enters the fixed tube 604 after passing through the hose 602 and the circular hole 703, enters the annular cover 503 through the U-shaped tube 603, and is sprayed out via the oil outlet 504, so that the lubricating oil is automatically applied to the surface of the guide rod 205, making the movement of the second sliding block 501 and the first sliding block 207 smoother, thereby ensuring the effect of the subsequent impact test.

What is claimed is:

1. A shock absorber performance testing device for vehicle engineering, comprising a box body and a box door, wherein a shock absorber body is provided in the box body, a U-shaped frame is fixedly connected to a bottom of the box body, a motor is fixedly connected to a bottom of the U-shaped frame, a rotating disk is fixedly connected to an output end of the motor, a moving block is connected to the rotating disk by a guide mechanism, two first connecting blocks symmetrically arranged are fixedly connected to a bottom of the moving block, two second connecting blocks symmetrically arranged are fixedly connected to a top of the rotating disk, insertion holes are formed on side walls of the first connecting block and the second connecting block, a plurality of groups of guide rods arranged in an array are fixedly connected to the bottom of the box body, two guide rods are arranged in each group of guide rods, retaining rings are fixedly sleeved on side walls of each group of guide rods, a first sliding block is slidably connected to the side walls of each group of guide rods, a counterweight block is fixedly connected to a top of the first sliding block, the counterweight block is pushed by a first pushing mechanism to move, a detection mechanism configured to detect movement of the moving block is arranged on the top of the rotating disk, and an oiling mechanism configured to automatically apply lubricating oil to the guide rod is arranged on the top of the first sliding block;
the first pushing mechanism comprises a pushing block, the pushing block comprises a first inclined surface, the first sliding block slides on the first inclined surface, the first sliding block is connected to the top of the rotating disk by a lifting mechanism, a pointer is arranged on a side wall of the moving block, and a scale mark is arranged on a side wall of the pushing block;
when the shock absorber body is subjected to performance test, two ends of the shock absorber body are respectively placed between the two first connection blocks and the two second connection blocks, and bolts are inserted into the insertion holes and into connection holes at the two ends of the shock absorber body for connection;
the motor is started, and the motor rotates to drive the rotating disk to rotate; when the first inclined surface abuts against the first sliding block, the first sliding block is pushed to move upward along the side wall of the guide rod, and the counterweight block is driven to move upward synchronously; when the pushing block passes over the first sliding block, the first sliding block and the counterweight block move downward under action of gravity and impact on the moving block, so that the shock absorber body is subjected to impact test; and a plurality of first sliding blocks and counterweight blocks are provided, so as to perform a plurality of continuous impact tests on the shock absorber body during the rotation of the rotating disk.

2. The shock absorber performance testing device for vehicle engineering according to claim 1, wherein the lifting mechanism comprises a first sleeve tube fixedly connected to a bottom of the pushing block, a first sleeve rod is inserted into the first sleeve tube, a lower end of the first sleeve rod is fixed to the top of the rotating disk, a threaded tube is fixedly connected to the bottom of the pushing block, a threaded rod is threadedly connected in the threaded tube, a lower end of the threaded rod is rotatably connected to the top of the rotating disk, and an adjusting nut is fixedly sleeved on a side wall of the threaded rod.

3. The shock absorber performance testing device for vehicle engineering according to claim 2, wherein the detection mechanism comprises two symmetrically arranged second sleeve rods fixedly connected to the bottom of the moving block, a second sleeve tube is sleeved on a side wall of the second sleeve rod, and a lower end of the second sleeve is fixed to the top of the rotating disk.

4. The shock absorber performance testing device for vehicle engineering according to claim 3, wherein the detection mechanism comprises a detection block fixedly connected to the side wall of the moving block, an L-shaped frame is fixedly connected to the top of the rotating disk, and a distance sensor is fixedly inserted into a top of the L-shaped frame.

5. The shock absorber performance testing device for vehicle engineering according to claim 4, wherein the oiling mechanism comprises a second sliding block sleeved on the side wall of the guide rod, a first spring is fixedly connected between the second sliding block and the first sliding block, two hollow annular covers are fixedly connected to a top of the second sliding block, the annular cover is provided with a plurality of oil outlets arranged in an array near the side wall of the guide rod, and an oil supply mechanism configured to drive the oil outlet to discharge oil is provided on a top of the box body.

6. The shock absorber performance testing device for vehicle engineering according to claim 5, wherein the oil supply mechanism comprises a plurality of oil tanks arranged in an array and fixedly connected to the top of the box body, a hose is fixedly connected to a bottom of each oil tank, a U-shaped tube is fixedly connected between tops of the two annular covers, a fixed tube is fixedly connected to a top of the U-shaped tube, a fixed cover is fixedly connected to an upper end of the fixed tube, a lower end of the hose is fixed to a top of the fixed cover, and an on-off mechanism is arranged in the fixed cover.

7. The shock absorber performance testing device for vehicle engineering according to claim 6, wherein the on-off mechanism comprises a sliding plate slidably connected in the fixed cover, a circular hole is formed in a top of the sliding plate, two first supporting blocks symmetrically arranged are fixedly connected to a side wall of the sliding plate, a T-shaped guide rod is fixedly connected to a side wall of each first supporting block, a second supporting block is sleeved on a side wall of each T-shaped guide rod, the second supporting block is fixed to a side wall of the fixed cover, a second spring is sleeved on the side wall of each T-shaped guide rod, and the sliding plate is moved by a second pushing mechanism.

8. The shock absorber performance testing device for vehicle engineering according to claim 7, wherein the second pushing mechanism comprises an L-shaped plate fixedly connected to the top of the first sliding block, the L-shaped plate comprises a second inclined surface, a push rod is arranged at the side wall of the sliding plate, and an end part of the push rod slides on the second inclined surface.

9. A shock absorber performance testing method for vehicle engineering using the shock absorber performance testing device for vehicle engineering according to claim 8, comprising the following steps:
S1: when the shock absorber body is subjected to performance test, two ends of the shock absorber body are respectively placed between the two first connection blocks and the two second connection blocks, and bolts are inserted into the insertion holes and into connection holes at the two ends of the shock absorber body for connection;
S2: the motor is started, and the motor rotates to drive the rotating disk to rotate; when the first inclined surface abuts against the first sliding block, the first sliding block is pushed to move upward along the side wall of the guide rod, and the counterweight block is driven to move upward synchronously; when the pushing block passes over the first sliding block, the first sliding block and the counterweight block move downward under action of gravity and impact on the moving block, so that the shock absorber body is subjected to impact test; a plurality of first sliding blocks and counterweight blocks are provided, so as to perform a plurality of continuous impact tests on the shock absorber body during the rotation of the rotating disk;
S3: the distance sensor detects a moving speed of the detection block and the moving block, and also test the performance of the shock absorber body; in addition, an impact frequency is adjusted by adjusting a speed of the motor and the rotating disk;
S4: during the test, the adjusting nut rotates to drive the threaded rod to rotate, thereby driving the threaded tube and the first sleeve tube to rise and fall, and then driving the pushing block to rise and fall; an impact height of the first sliding block and the counterweight block is adjusted by the scale mark indicated by the pointer, so that an impact amplitude is adjusted conveniently;
S5: when the first sliding block moves upward along the side wall of the guide rod, the second sliding block is driven by the first spring to synchronously move upward; in a case that a surface of the guide rod is not lubricated enough, the second sliding block gets stuck when the second sliding block and the first sliding block move upward; in this case, the first spring is compressed, and a distance between the first sliding block and the second sliding block is smaller, so that the end part of the push rod slides on the second inclined surface, then the sliding plate is pushed to slide toward the fixed cover, and the circular hole coincides with the hose; meanwhile, the second spring is compressed; and in this case, the lubricating oil in the oil tank enters the fixed tube after passing through the hose and the circular hole, enters the annular cover through the U-shaped tube, and is sprayed out via the oil outlet, so that the lubricating oil is automatically applied to the surface of the guide rod, making the movement of the second sliding block and the first sliding block smoother, thereby ensuring the effect of the subsequent impact test.
